(19) United States
(12) Patent Application Publication
(10) Pub. No.: US 2018/0146631 A1
(43) Pub. Date: May 31, 2018

(54) AUTOMATED DYNAMIC ADAPTIVE DIFFERENTIAL AGRICULTURAL CULTIVATION SYSTEM AND METHOD

(71) Applicant: CropX Technologies, Ltd., Herzliya (IL)

(72) Inventors: Yossi Haran, Modi'in-Macabim-Reut (IL); Isaac Bentwich, Ein Ayala (IL)

(21) Appl. No.: 15/573,778

(22) PCT Filed: May 15, 2016
(86) PCT No.: PCT/IL2016/050510

§ 371 Date: Nov. 13, 2017

Related U.S. Application Data
(60) Provisional application No. 62/161,704, filed on May 14, 2015.

(51) Int. Cl. A01G 25/16

(52) U.S. Cl. CPC A01G 25/167; H04Q 9/00

(57) ABSTRACT

An automated dynamic adaptive differential agricultural cultivation system, constituted of: a sensor input module arranged to receive signals from each of a plurality of first sensors positioned in a plurality of zones of a first field; a multiple field input module arranged to receive information associated with second sensors from a plurality of fields; a dynamic adaptation module arranged, for each of the first sensors of the first field, to compare information derived from the signals received from the respective first sensor with a portion of the information received by the multiple field input module and output information associated with the outcome of the comparison; a differential cultivation determination module arranged, responsive to the output information of the dynamic adaptation module, to determine a unique cultivation plan for each zone of the first field; and an output module arranged to output a first function of the determined unique cultivation plans.

### TECHNICAL FIELD

The invention relates generally to the field of agricultural irrigation, and in particular to an automated dynamic adaptive differential agricultural cultivation system and method.

### REFERENCE TO RELATED APPLICATIONS

This application claims priority from U.S. provisional patent application Ser. No. 62/161,704, filed May 14, 2015 and entitled “AUTOMATED DYNAMIC ADAPTIVE DIFFERENTIAL AGRICULTURAL CULTIVATION”, the entire contents of which are incorporated herein by reference.

### BACKGROUND OF THE INVENTION

Differential irrigation, also known as variable rate irrigation (VRI), allows for providing different amounts, and scheduling, of irrigation to different parts of a field. Hardware has been developed for use in differential irrigation and other aspects of differential cultivation, such as differential seeding, fertigation and chemigation. A method and system for automated differential irrigation has been developed and described in PCT patent application publication WO 2014/073985, published May 15, 2014 and entitled ‘A METHOD AND SYSTEM FOR AUTOMATED DIFFERENTIAL IRRIGATION’, the entire contents of which is incorporated herein by reference. Unfortunately, the described automated differential irrigation system does not disclose a method for dynamically adapting differential irrigation, and/or other types of agricultural cultivation.

### SUMMARY OF THE INVENTION

Accordingly, it is a principal object of the present invention to overcome at least some of the disadvantages of prior art advertisement display methods and systems. This is accomplished in one embodiment by an automated dynamic adaptive differential agricultural cultivation system, comprising: a sensor input module, the sensor input module arranged to receive signals from each of a plurality of first sensors, each of the plurality of first sensors positioned in a respective one of a plurality of zones of a first field; a multiple field input module, the multiple field input module arranged to receive information associated with second sensors from a plurality of second fields, the second fields different than the first field; a dynamic adaptation module, the dynamic adaptation module arranged, for each of the first sensors, to compare information derived from the signals received from the respective first sensor with a portion of the information received by the multiple field input module from the second sensors and output information associated with the outcome of the comparison; a differential cultivation determination module, the differential cultivation determination module arranged, responsive to the output information of the dynamic adaptation module, to determine a unique cultivation plan for each of the plurality of zones of the first field; and an output module, the output module arranged to output a first function of the determined unique cultivation plan for each of the plurality of zones of the first field.

In one embodiment, the differential cultivation determination module is arranged to periodically update the determined unique cultivation plans responsive to the information output by the dynamic adaptation module. In another embodiment, the dynamic adaption module is arranged to determine a cultivation curve for each of the plurality of zones of the first field, responsive to the outcomes of the respective comparisons, wherein the unique cultivation plan of each of the plurality of zones is determined responsive to the determined cultivation curve.

In one further embodiment, the determined cultivation curve is a soil drying curve. In another further embodiment, the information received by the multiple field input module comprises a plurality of cultivation curves, each of the plurality of cultivation curves associated with a respective zone of one of the plurality of second fields.

In one further embodiment, the system further comprises an event identification module, the event identification module arranged to detect a meteorological event, wherein responsive to the meteorological event detection, the dynamic adaption module is arrange to periodically sample the received signals from each of the plurality of first sensors and perform the comparison of information responsive to the periodically sampled signals. In another further embodiment, the system further comprises an event initiation module, the event initiation module in communication with each of a plurality of cultivation devices, each of the plurality of cultivation devices positioned in a respective one of the plurality of zones of the first field, the event initiation module arranged to initiate an event at at least one of the plurality of cultivation devices, wherein responsive to the event initiation, the dynamic adaptation module is arranged to periodically sample the received signals from each of the plurality of first sensors and perform the comparison of information responsive to the periodically sampled signals.

In one further embodiment, the system further comprises: the plurality of first sensors; and an event initiation module, the event initiation module in communication with each of the plurality of first sensors, wherein each of the plurality of first sensors is arranged to alternately output a first sense signal exhibiting a first power magnitude and a second sense signal exhibiting a second power magnitude, the second power magnitude greater than the first power magnitude, wherein each of the plurality of first sensors is further arranged to sense the surrounding soil moisture level responsive to any of the respective output first sense signal and second sense signal, wherein the event initiation module is arranged to initiate an event at at least one of the plurality of first sensors, such that each of the plurality of first sensors is arranged to output the second sense signal, and wherein responsive to the event initiation, the dynamic adaptation module is arranged to periodically sample the received signals from each of the plurality of first sensors and perform the comparison of information responsive to the periodically sampled signals.

In one embodiment, the output module is in communication with each of a plurality of cultivation devices, each of the plurality of cultivation devices positioned in a respective one of the zones of the first field, and wherein, for each of the plurality of zones of the first field, the output module is arrange to output the respective determined unique cultivation plan function to the respective one of the plurality of cultivation devices positioned in the respective zone. In one further embodiment, each of the plurality of cultivation devices is an irrigation device, each of the determined unique cultivation plan functions comprising the amount of irrigation to be provided by the respective irrigation device.

In one independent embodiment, an automated dynamic adaptive differential agricultural cultivation method is provided, the method comprising: receiving signals from each of a plurality of first sensors, each of the plurality of first sensors positioned in a respective one of a plurality of zones of a first field; receiving information associated with second sensors from a plurality of second fields, the second fields different than the first field; for each of the first sensors, comparing information derived from the signals received from the respective first sensor with a portion of the information received from the second sensors and outputting information associated with the outcome of the comparison; responsive to the output information associated with the outcome of the comparison, determining a unique cultivation plan for each of the plurality of zones of the first field; and outputting a first function of the determined unique cultivation plan for each of the plurality of zones of the first field.

In one embodiment, the method further comprises periodically updating the determined unique cultivation plans responsive to the output information. In another embodiment, the method further comprises determining a cultivation curve for each of the plurality of zones of the first field, responsive to the outcomes of the respective comparisons, wherein the unique cultivation plan of each of the plurality of zones is determined responsive to the determined cultivation curve.

In one further embodiment, the determined cultivation curve is a soil drying curve. In another further embodiment, the received information associated with the second sensors comprises a plurality of cultivation curves, each of the plurality of cultivation curves associated with a respective zone of one of the plurality of second fields.

In one further embodiment, the method further comprises: detecting a meteorological event; responsive to the meteorological event detection, periodically sampling the received signals from each of the plurality of first sensors; and performing the comparison of information responsive to the periodically sampled signals. In another further embodiment, the method further comprises: initiating an event at at least one of a plurality of cultivation devices, each of the plurality of cultivation devices positioned in a respective one of the plurality of zones of the first field; responsive to the event initiation, periodically sampling the received signals from each of the plurality of first sensors; and performing the comparison of information responsive to the periodically sampled signals.

In one further embodiment, each of the plurality of first sensors is arranged to alternately output a first sense signal exhibiting a first power magnitude and a second sense signal exhibiting a second power magnitude, the second power magnitude greater than the first power magnitude, wherein each of the plurality of first sensors is further arranged to sense the surrounding soil moisture level responsive to any of the respective output first sense signal and second sense signal, wherein the method further comprises: initiating an event at at least one of the plurality of first sensors, such that each of the plurality of first sensors is arranged to output the second sense signal; responsive to the event initiation, periodically sampling the received signals from each of the plurality of first sensors; and performing the comparison of information responsive to the periodically sampled signals.

In one embodiment, the method further comprises, for each of the plurality of zones of the first field, outputting the respective first function of the determined unique cultivation plan to a respective one of a plurality of cultivation devices, each of the plurality of cultivation devices positioned in a respective one of the plurality of zones of the first field. In one further embodiment, each of the plurality of cultivation devices is an irrigation device, each of the determined unique cultivation plan functions comprising the amount of irrigation to be provided by the respective irrigation device.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIG. 1 illustrates a high level block diagram of a plurality of fields and databases containing information regarding the plurality of fields, according to certain embodiments;

FIGS. 2A-2B illustrate a high level block diagram of an automated dynamic adaptive differential agricultural cultivation system implemented on a user device, according to certain embodiments;

FIG. 3 illustrates a high level flow chart of a first method utilizing a dynamic adaptation module of the system of FIGS. 2A-2B, according to certain embodiments;

FIG. 4 illustrates a high level flow chart of a second method utilizing a dynamic adaptation module of the system of FIGS. 2A-2B, according to certain embodiments;

FIG. 5 illustrates a high level flow chart of a method of active calibration of information collected by sensors positioned in agricultural fields, according to certain embodiments;

FIG. 6 illustrates a high level flow chart of a method of actively calibrating information collected by a sensor positioned in an agricultural field by wetting the surrounding area of the sensor;

FIG. 7 illustrates a high level flow chart of a method of passively analyzing information collected from sensors position in a field and dynamically adjusting a differential cultivation plan, according to certain embodiments;

FIG. 8 illustrates a high level flow chart of a method of identifying and analyzing zones in a field in a dynamic manner, according to certain embodiments;

FIGS. 9A-9B illustrate high level block diagrams of calibration systems, according to certain embodiments;

FIGS. 10A-10B illustrate high level block diagrams of systems for identifying and analyzing zones in a field in a dynamic manner, according to certain embodiments;

FIGS. 11A-11D illustrate various high level views of a field sensor, according to certain embodiments;

FIG. 11E illustrates a high level schematic view of a calibration circuitry of the field sensor of FIGS. 11A-11D, according to certain embodiments; and

FIG. 12 illustrates a high level flow chart of an automated dynamic adaptive differential agricultural cultivation method, according to certain embodiments.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

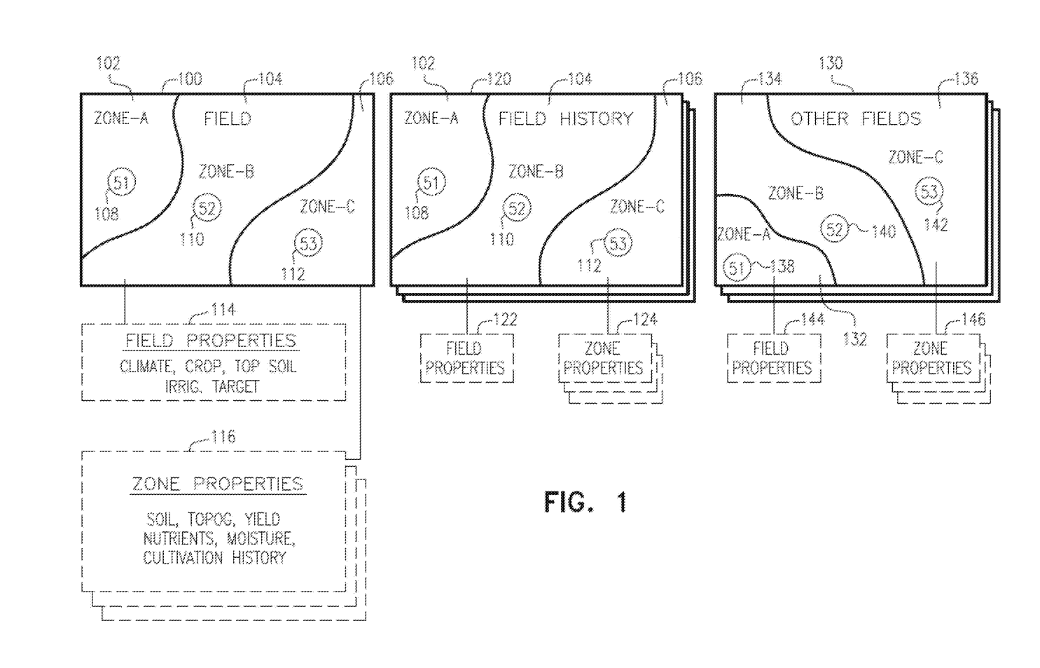

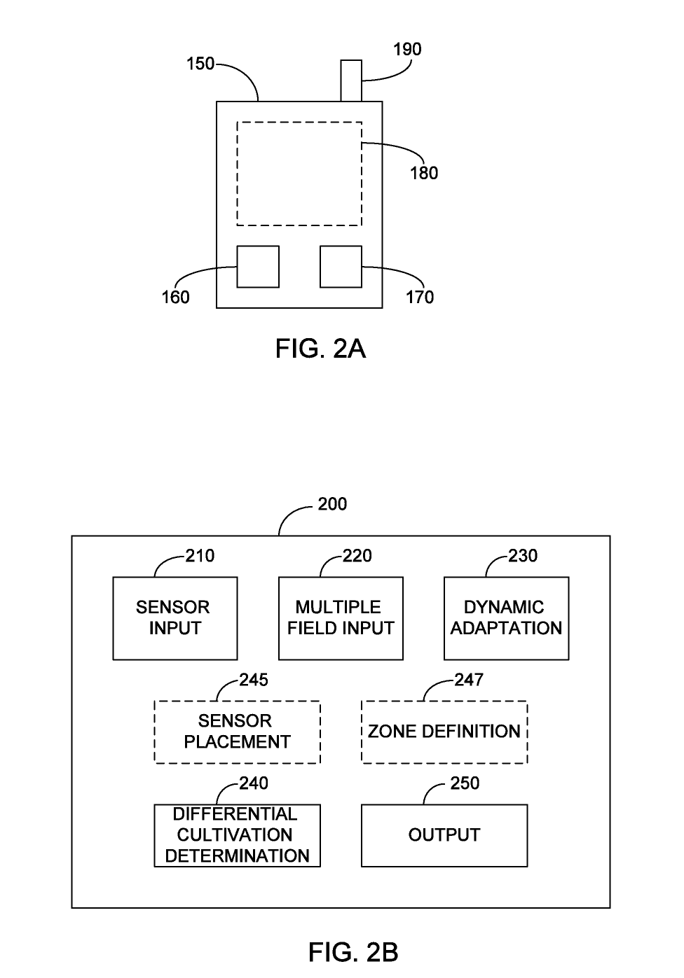

FIG. 1 illustrates a high level block diagram of a plurality of fields and a plurality of databases containing information regarding the plurality of fields, according to certain embodiments. Particularly, a first field 100 is illustrated. First field 100 is typically not uniform, its topography is typically not completely flat and its soil composition is typically not completely uniform. Accordingly, it is beneficial to divide first field 100 into several cultivation zones, wherein cultivation conditions in each such zone are relatively uniform. FIG. 1 illustrates first field 100 as comprising three cultivation zones: 102; 104; and 106. It is appreciated that this division into three zones 102, 104 and 106 is meant For example only, and first field 100 may comprise more or less than three zones. Modes by which first field 100 is divided into zones 102, 104 and 106 will be described further below in relation to FIGS. 2A-2B.

A plurality of sensors, denoted 108, 110 and 112, are preferably positioned within zones 102, 104 and 106, respectively. A method of positioning of sensors 108, 110 and 112 within zones 102, 104 and 106 is further described herein below in relation to FIGS. 2A-2B.

A field properties database 114 contains information regarding properties which are associated with first field 100. In one embodiment, these properties include climate data, crop data and top-soil cultivation data of first field 100. In one further embodiment, top-soil cultivation data includes data on cultivation and other procedures performed on first field 100 which may impact properties of the top-soil of the field, including, but not limited to, the type of tillage used, etc. In another embodiment, field properties database 114 contains information regarding parameters which may be set by a farmer, in order to drive differential cultivation of the first field 100. For example, these may include an irrigation target parameter, expressed as a percentage relative to the range between the refill point of first field 100, i.e. the moisture content of first field 100 at which an irrigation system is set to irrigate first field 100, and the maximum moisture capacity of first field 100 (e.g. 0% corresponds to the refill point and 100% refers to the maximum moisture capacity). For example, by setting the irrigation goal to 100% (i.e. maximum moisture capacity), the farmer guides the system to calculate and automatically irrigate each zone by the amount of water that is the deficit between the measurement taken in that zone, and the maximum moisture capacity of the soil in that zone. This, so as to bring the soil of each zone to the maximum moisture level. It is appreciated that each of zones 102, 104 and 106 may require different amounts of irrigation in order to reach this goal. Similarly, in one embodiment field properties database 114 contains information regarding similar properties to guide differential seeding, fertilizing and other agricultural cultivation procedures.

A zone properties database 116 contains information regarding properties associated with each of cultivation zones 102, 104 and 106. These in one embodiment include properties which are relatively constant, i.e. they are typical of the zone and relatively unchanging over time (e.g. soil type), and properties that change over time (e.g. current soil moisture value). In one non-limiting embodiment, zone properties database 116 contains information about soil type (preferably for deep and superficial soil), soil moisture content, soil topography water retention properties (including refill point), maximum moisture capacity, soil calibration curve, drying/wetting curve, level of nutrients, curve of level of nutrients over time, temperature, temperature curve and cultivation history (e.g. history of prior application of water or fertilizer).

A field history database 120 is also illustrated, field history database 120 containing information regarding a plurality of historic records, recorded at different time-points, of first field 100 and its zones 102, 104 and 106, as recorded by their respective sensors 108, 110 and 112. Field history database 120 comprises: a field properties database 122 and a zone properties database 124. Field properties database 122 contains information regarding a plurality of sets of properties, the same properties as those of field properties 116, but recorded at different historic points in time. For example, field properties database 114 may contain information documenting that the current crop of first field 100 is ‘corn’, whereas the record-set of field properties database 122 may show that first field 100 grew alfalfa last year, and soybeans the previous year. Zone properties database 124, similar to zone properties database 116, comprises information regarding historical sets of zone properties of zones 102, 104 and 106 of first field 100, each such set corresponding to a point in time. For example, it may show that yesterday soil moisture measured 68 mm, 80 mm and 94 mm in zones 102, 104 and 106, respectively, whereas the previous day these measured 40 mm, 60 mm and 80 mm, respectively.

Second fields 130 are also illustrated. Particularly, fields 130 are a plurality of fields from a plurality of farms, each such field 130 comprising zones 132, 134 and 136, and having corresponding sensors 138, 140 and 142, respectively positioned within zones 132, 134 and 136. Although three zones and three sensors are illustrated for each field 130, this is not meant to be limiting in any way and each field 130 can be separated into any number of zones with any number of sensors. It is appreciated that the zones 132, 134 and 136 and sensor 138, 140 and 142, are meant as generic representations of zones and sensors therein of each one of fields 130, and the zones and the sensors can differ from field to field.

Each field 130 has associated therewith a respective one of a plurality of field properties databases 144, and each of zones 132, 134 and 136 is associated with a respective one of a plurality of zone properties databases 146. Field properties databases 144 and zone properties databases 146 are in all respects similar to field properties database 114 and zone properties database 116, with the information stored therein reflecting the specific properties of the individual fields 130 and their zones.

FIGS. 2A-2B illustrates a high level block diagram of an automated dynamic adaptive differential agricultural cultivation system 200, according to certain embodiments, implemented on a user device 150, FIGS. 2A-2B being described together, further in reference to FIG. 1. User device 150 comprises: a processor 160; a memory 170; an optional user interface 180; and a communications module 190. Automated dynamic adaptive differential agricultural cultivation system 200 comprises: a sensor input module 210; a multiple field input module 220; an dynamic adaptation module 230; a differential cultivation determination module 240; an optional zone definition module 245; an optional sensor placement module 247; and an output module 250. Automated dynamic adaptive differential agricultural cultivation system 200 is in one embodiment implemented by computer readable instructions stored on memory 170 and executed by processor 160. In another embodiment, each of sensor input module 210, multiple field input module 220, dynamic adaptation module 230, differential cultivation determination module 240, optional zone definition module 245, optional sensor placement module 247 and output module 250 are each implemented as a dedicated circuitry.

In one embodiment (not shown), one or more of field properties database 114, zone properties database 116, field properties database 122, zone properties database 124, field properties databases 144 and zone properties databases 146 each comprise a portion of memory 170. In another embodiment, one or more of field properties database 114, zone properties database 116, field properties database 122, zone properties database 124, field properties databases 144 and zone properties databases 146 are located at a central system in communication with user device 150 via communications module 190. Optional user interface 180 comprises in one non-limiting embodiment a touch screen. In one non-limiting embodiment, communications module 190 comprises one or more of: an antenna; a wired/wireless connection to one or more external systems; and a connection to the Internet.

An agricultural field is typically not uniform. Its soil composition varies across a field, such as more clay-like in one part and more sandy in another part, and therefore these two parts may retain water differently as is well known in the art. In addition, the field may typically be not completely flat, and so a first area of the field may be a catchment area and hence will tend to retain water more, whereas a second area may be a topographical protrusion and hence will tend to retain water less. Different parts of the field therefore require different amounts of irrigation, because of these properties of the zones within the field.

Sensor input module 210, multiple field input module 220 and output module 250 are each in communication with communications module 190, the connections not shown for simplicity. Sensor input module 210 is arranged to receive, via communications module 190, signals from each of sensors 108, 110 and 112 of first field 100. As described above, three sensors 108, 110 and 112 have been illustrated, however this is not meant to be limiting in any way. Particularly, each sensor 108, 110 and 112 is in one embodiment a representation of a plurality of sensors in the respective one of zones 102, 104 and 106. In a preferred embodiment, each such sensor 108, 110 and 112 represent several sensors placed in one location, such as several sensors placed at several depths, e.g. at two depths; and/or several types of sensors such as soil moisture sensors, soil nutrient sensors, and other sensors placed at the same location, preferably integrated into a single unit. It is also appreciated that sensors 108, 110 and 112 may be placed in some but not necessarily in all of zones 102, 104 and 106, and that more than one sensor 108, 110 and 112 at more than one location may be placed in each zone 102, 104 and 106, respectively. It is also appreciated that sensors 108, 110 and 112 are not necessarily physically placed in the soil, but may also be remote sensors constructed and operative to collect measurements from their respective zones 102, 104 and 106. Furthermore, in one embodiment a single remote sensor is arranged to take measurements from different zones 102, 104 and 106, thus the three sensors 108, 110 and 112 can physically be a single sensor carrying out the functionality of these three.

The received signals from sensors 108, 110 and 112 are stored in a sensor data storage 215. In one embodiment, sensor data storage 215 comprises a respective portion of memory 170.

In one embodiment, multiple field input module 220 is arranged to receive, via communications module 190, spatial data associated with first field 100. For example, the spatial data can comprise soil-type mapping and topographical map data. Soil mapping may be obtained from existing soil-maps, which are often in the public domain, or may be obtained through electromagnetic (EM) or electro-conductivity (EC) mapping, as is known in the art. Spatial data may also comprise a spatial-capture, or a time-series plurality of spatial captures of first field 100 while soil of first field 100 is wetting and or is drying up. Such spatial captures may include but are not limited to photographic images, hyper-spectral captures, or any other mode of spatial capture which correlates to wetness of soil. Wetting or drying may be naturally occurring, such as related to rain events tracked along time, and may be artificial, such as initiated mechanical irrigation events, as will be described below.

In one further embodiment, the spatial data is received from a central server. In another further embodiment, at least a portion of the spatial data is entered at optional user interface 180. The received spatial data is stored on a spatial data storage 217. In one embodiment, spatial data storage 217 comprises a respective portion of memory 170. Responsive to the received spatial data, optional zone definition module 245 is arranged to determine cultivation zones for first field 100, i.e. zones 102, 104 and 106 described above. As described above, three zones 102, 104 and 106 are illustrated, however this is not meant to be limiting in any way, and any appropriate number of zones can be determined without exceeding the scope. In one preferred embodiment, optional zone definition module 245 is arranged to analyze topographical features, such as catchment, slope and aspect, and analyze a soil-type map such as an EM or EC map, the cultivation zones determined responsive to both analyzations. In another preferred embodiment, optional zone definition module 245 is arranged to define effective, extrapolatable cultivation zones, whereby water retention properties of each zone are relatively uniform across that zone. Accordingly, a reading from a sensor placed in such a zone is effectively representative across the entire zone. Optional sensor placement module 247 is arranged, responsive to the determined zones of optional zone definition module 245, to determine the appropriate positions for sensors 108, 110 and 112 in determined zones 102, 104 and 106, respectively. In one embodiment, output module 250 is arranged to output, via communications module 190, information regarding the determined zones and sensor placements.

In another embodiment, dividing first field 100 into zones also utilizes analysis of yield-maps, as is known in the art. In yet another embodiment, dividing first field 100 into zones utilizes analysis of a spatial-capture, or a time-series plurality of spatial captures of first field 100, while soil of first field 100 is wetting and or is drying up. Such spatial captures may include but are not limited to photographic images, hyper-spectral captures, or any other mode of spatial capture which correlates to wetness of soil. Wetting or drying may be naturally occurring, such as related to rain events tracked along time, and may be artificial, such as initiated mechanical irrigation events, as will be described below. In a preferred embodiment, an irrigation event may be initiated for the purpose of determining cultivation zones, and time-serial captures of first field 100 is taken to track and analyze the wetting and/or drying pace and dynamics of soil of first field 100. In another preferred embodiment, time-series captures of first field 100, such as from historic satellite captures, are utilized and compared with records of rainfall events.

The determined sensor placement is effective in reliably defining relatively uniform cultivation zones 102, 104 and 106 in first field 100. Advantageously, a single sensor 108, 110 or 112 in each such zone is reliably able to represent soil moisture of the entire zone in which it is placed. This is in stark difference to the prior-art, where common practice is, for example, relying primarily on EM mapping and/or yield maps for defining cultivation zones, while ignoring analysis of topographical features. As described above, optional zone definition module 245 and optional sensor placement module 247 integrate sophisticated analysis of topographical features, such as catchment area, slope and aspect, thereby deriving reliably uniform cultivation zones, such that readings from a single sensor placed in each such zone are representative of the entire zone. Accordingly, three sensors in three such zones are typically sufficient for automating cultivation across a large field, such as a 125 acre field. To reach similar results using prior-art approaches, one would be forced to use a much larger number of sensors, which becomes prohibitive, not just cost and labor wise, but also in their utter disruption of cultivation of the field.

In one embodiment, a software app running on processor 160 displays zones 102, 104 and 106 on optional user interface 180 and guides the user to physically navigate to each of zones 102, 104 and 106 in first field 100, so as to place a sensor 108, 110 and 112 in each of these zones, respectively. In one further embodiment, the app identifies the sensor which the user is holding, preferably using a proximity chip located in the sensor unit or by scanning a QR code on the sensor unit or other similar methods, and automatically associates the sensor to the respective one of zones 102, 104 and 106 in which it is placed, based on the mobile device's GPS location and comparing it to the zones that are stored in the system. This means that sensor units are ‘agnostic’ to their destination, and are ‘initiated’ and associated to their physical location, wireless connectivity and database connection with a single tap. In another further embodiment, in the event that the user attempts to place a sensor in the wrong place and/or wrong zone (e.g. when attempting to place a sensor in a zone that already has a sensor in it), the app may preferably alert the user to this error.

Differential cultivation determination module 240 is arranged to determine a unique cultivation plan for each one of zones 102, 104 and 106 of first field 100. In one embodiment, the unique cultivation plan comprises one or more of: an irrigation plan; a seeding plan; a fertilization plan; a tilling plan; and an insecticide plan. For ease of explanation, the below will be described in relation to an irrigation plan, however this is not meant to be limiting in any way. Particularly, differential cultivation determination module 140 is arranged to generate a differential irrigation map with the amount of optimal irrigation required by different zones 102, 104 and 106 of first field 100. As will be described below, the determined cultivation plan is further determined responsive to dynamic adaptation module 230. In one embodiment, appropriate commands in accordance with the determined cultivation plan are output by output module 250 to a cultivation system. For example, irrigation commands associated with the determined irrigation plan is output to an irrigation system, such as a plurality of pivot irrigator devices positioned within first field 100, such that each irrigator device applies the appropriate amount of water to the respective portion of first field 100.

In one embodiment, differential cultivation determination module 240 is arranged to determine a differential irrigation map by comparing soil moisture readings received from sensors 108, 110 and 112 to soil properties of the soil in the respective zone 102, 104, 106, such as a maximum moisture capacity and refill point, and to an irrigation level goal and/or other parameters set by the user at optional user interface 180. It is appreciated that these and many other parameters may be used in such a formula to determine the amount of irrigation that is appropriate for that zone. These include, but are not limited to, other properties of the zone and/or the field, such as the crop grown, its phase, and various meteorological data.

Dynamic adaptation module 230 enables adaptive cultivation, which automatically adapts differential cultivation based on ongoing accumulated data both from second fields as well as historic data, as will be described herein. Particularly, multiple field input module 220 is arranged to receive, optionally via communications module 190, information associated with sensors 138, 140 and 142 of second fields 130, optionally from field properties database 144 and zone properties database 146. Additionally, or alternately, multiple field input module 220 is in one embodiment arranged to retrieve information from field properties database 122 and zone properties database 124, i.e. historic information from first field 100.

Dynamic adaptation module 230 is arranged, for each of sensors 108, 110 and 112 of first field 100, to compare information derived from the signals received from the respective sensor with a portion of the information associated with sensors 138, 140 and 142, and/or associated with historic readings of sensors 108, 110 and 112, as received by multiple field input module 220. In one embodiment, the information received by multiple field input module 220 further comprises spatial information associated with each zone 134, 136 and 138 of each second field 130 and the received spatial information is compared to the spatial data and/or sensor data of first field 100. Particularly, sensors of first field 100 are compared to sensors of second fields 130 which are located within zones of similar spatial properties. Dynamic adaptation module 230 is arranged to output a predetermined function of the outcomes of the comparisons to differential cultivation determination module 240. Particularly, as will be described below, dynamic adaptation module is arranged to update a formula utilized by differential cultivation module 240 to determine the differential cultivation plan. Responsive to the output function of dynamic adaptation module 230, differential cultivation determination module 240 is arranged to modify and modulate the differential cultivation plan.

In one preferred embodiment, dynamic adaptation module 230 utilizes various machine learning methods known in the art to continuously train itself on soil-sensing data that is continuously captured by the system, and which originates from, and is correlated to, cultivation zones, preferably ones that are based on topographic feature analysis together with soil-type mapping.

For example, the system typically starts with a simple generic formula that calculates how much water should be irrigated onto a particular zone 108, 110, 112 in first field 100 based on the soil-moisture reading from a sensor in that zone, and properties such as moisture retention capacity of that zone, preferably based on soil properties together with topographic features, such as catchment, slope and aspect.

There are many factors that are relevant to such formula, which can further improve it dynamically. For example, dynamic adaptation module 230 in one embodiment queries field properties databases 144 and zone properties databases 146 and identifies zones 134, 136 and 138 in second fields 130 that share the soil type of one or more of zones 102, 104, 106 of first field 100, and analyzes their real-life drying pattern, hence improving the formula. Over time, dynamic adaptation module 230 can compare and derive optimization from increasingly complex combinations of properties. For example, in one embodiment dynamic adaptation module 230 seeks to learn the pattern not just of zones with a similar soil type, but also with similar crop, or further also with similar growth phase of crop, or yet further with common topographic feature or features such as north facing slopes that are steeply inclined. Based on these groupings of similar properties, patterns can be determined, which improve the differential cultivation formula of dynamic adaptation module 230.

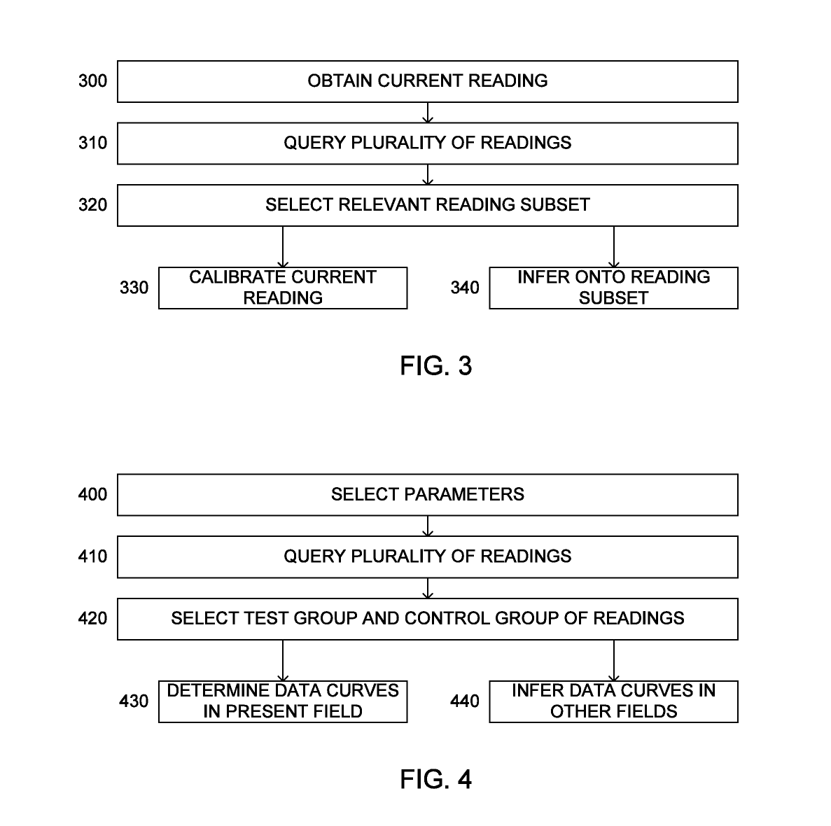

FIG. 3 illustrates a high level flow chart of a first method utilizing dynamic adaptation module 230, according to certain embodiments. In stage 300, a current sensor reading is obtained. In stage 310, a plurality of sensor readings are queried, and in stage 320 a relevant reading subset is selected. In one non-limiting example, the current reading 300 is a soil moisture measurement obtained from a sensor placed in a zone of clay type soil. The plurality of readings of stage 310 are a database of soil moisture measurements, or serial soil moisture measurements (i.e. soil moisture curves), obtained from a large plurality of zones in various fields, over time. The selected relevant reading subset of stage 320 is a subset of the above mentioned soil moisture measurements or soil moisture curves of stage 310, obtained from zones that have clay type soil, similar to the current reading of stage 300.

In stage 330, a calibration process is performed. Specifically, dynamic adaptation module 230 is arranged to use the selected reading subset of stage 320 to calibrate a reference for the current reading of stage 300. In one non-limiting example, by analysis of the subset of soil moisture measurements or curves obtained from similar clay type soil, it is possible to determine improved calibration curves for this soil type and to more accurately determine the optimal refill point and maximum moisture capacity, thereby determining how far off the current reading is from optimum. In other words, the calibration curve provides data on the expected change in sensor measurements responsive to predetermined conditions and as a result the current reading can be compared to the calibration curve to determine from the current sensor measurement what the status of the field is. It is appreciated that this example is not meant to be limiting and the reading subset may be selected according to any property of the zone or field, and may particularly be applied to a combination of such properties. For example, a subset of readings are selected from a zone which not only exhibits a similar soil type to the zone of the current reading of stage 300, but also exhibits a similar crop, a similar crop phase, and/or a similar history.

Alternately, in stage 340, the current reading of stage 300 is analyzed and inferred onto the relevant readings subset. In one non-limiting example, the soil moisture measurement of the current reading of stage 300 is used in order to predict what the soil moisture would be in similar zones within the selected relevant reading subset of stage 320, i.e. zones which share properties with the zone and field of the current reading, but where measurements were not taken, or are sought to be corroborated. For example, a measurement in one zone of clay type soil, with a certain topographic wetness score, where certain rainfall has now been recorded, and growing a certain crop at a certain growth phase, is received in stage 300. This reading is inferred onto other zones on that farm or elsewhere, where the soil is also clay, has a similar topographic wetness score, similar rainfall and similar crop and growth phase, thereby providing data estimation for the other zones without receiving any sensor readings. The data estimations can be used for updating field properties databases 144 and zone properties databases 146.

It is appreciated that the method of stage 300-340 can be applied to any crop, soil or meteorological properties, or a combination thereof. It is also appreciated that there are many computerized pattern recognition methods known in the art that may be used for the calibration process of stage 330 and the inferring process of stage 340. It is further appreciated that this method may be applied to spatial data and not just to sensor data as in the examples above. For example, the current reading of stage 300 can be a yield map, and the selected relevant reading subset of stage 320 can be a set of yield maps that are deemed comparable, and from which pattern recognition is used to better analyze the current reading of stage 300 in the calibration process of stage 330. Other examples of the method of stages 300-340 comprise, and are not limited to, analysis of top-soil cultivation, day-time vs. night-time soil moisture curves, and various other properties.

In another embodiment, the method of stage 300-340 is performed at an external central system, and the determined data is transmitted to multiple field input module 220 for use in differential cultivation, as described above.

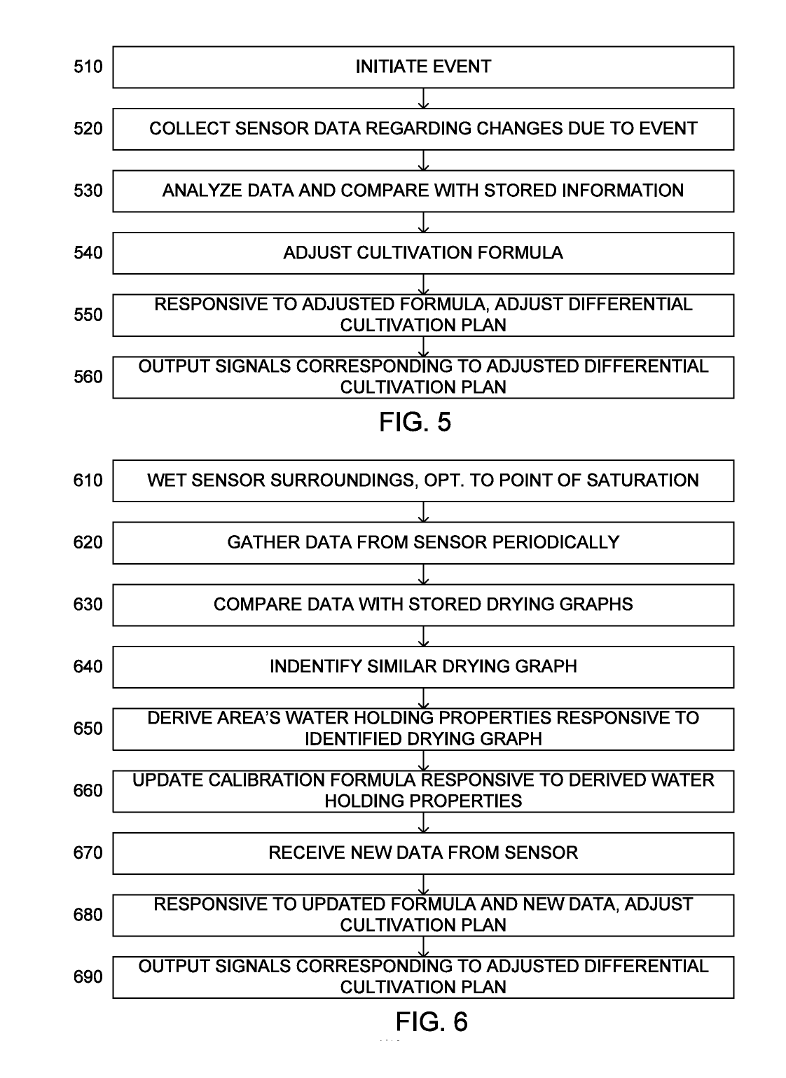

The methods of FIGS. 5-10 described below provide additional examples associated with the method of stages 300-340.

FIG. 4 illustrates a high level flow chart of a second method utilizing dynamic adaption module 230, according to certain embodiments. In stage 400, a user, who may be a research or development staff, selects one or more parameters at optional user interface 180. In stage 410, a plurality of sensor readings are queried. In stage 420, responsive to the selected parameters of stage 400, a test group of readings and a control group of readings are extracted from the queried sensor readings of stage 410. The test group readings exhibit predetermined properties associated with the selected parameters of stage 400 and the control group readings do not exhibit these predetermined properties. In one embodiment, the parameters selected in stage 400 also comprises one or more parameters that the user wants to evaluate in the test group versus the control group.

In stage 430, a calibration process is performed, as described above in relation to stage 330. In one non-limiting example, parameters selected include a crop, such as maize, a crop-phase, such as a specific week of growth, and the soil-topography zone (i.e. an assessment of the water retention of a zone based on a combination of topographic features including catchment, slope and aspect, together with soil-type mapping). The test group readings include measurements from sensors in zones answering these criteria, as opposed to the control group readings that do not. Based on these readings, dynamic adaption module 230 learns new rules that enable the system to be a learning system, which dynamically adapts based on its exposure to data. In one non-limiting example, dynamic adaption module 230 determines a pattern of daytime soil moisture curves and nighttime soil moisture curves from zones of first field 100 having the selected properties by comparing soil moisture readings of the test group vs. the control group. Daytime curves from such a test group (assuming there is no precipitation) indicate the combined effect of evapotranspiration together with plant utilization, whereas nighttime curves indicate primarily plant utilization. Thus, the determined soil moisture curves are used to calibrate the interpretation of new readings from such zones in the future, i.e. future readings are compared to the determined soil moisture curves to determine the actual status of the field. Alternately, in stage 440, soil moisture curves, or other data curves, are determined and are used to predict the soil status in similar zones in second fields 130, as described above in relation to stage 340.

The method of stages 400-440 are in one embodiment also utilized in improving calibration and improving the accuracy of determination of soil type in each zone. The determination of the soil type in each zone is in one embodiment an automated determination, which does not require laboratory analysis of a soil sample. In one preferred embodiment, this determination is based on an analysis of sequential soil-moisture measurements in the field, which thereby determines a pattern that is typical to a soil type and can differentiate a specific soil type from other soil types. This pattern analysis is in one embodiment based at least in part on recognizing a soil drying pattern typical of a particular soil type, as detailed below. In another embodiment, the pattern analysis is also based on identifying a pattern of a soil of a specific field or zone and deducing its specific water-holding properties. In one preferred embodiment, the system determines the general type of soil in a zone, such as ‘clay’, and deduces the water-holding properties from the general soil type, such as the maximum moisture capacity and the refill point of generic ‘clay’, as described above. These determined properties are then utilized for this field. In another embodiment, the system determines not only that the soil in this field is generally ‘clay’, but the exact make of clay in the specific field, by assessing its specific water holding capacity properties by analyzing sequential soil moisture measurements, optionally including determining a soil moisture drying curve.

The method of stages 400-440 is in one embodiment used in adapting the logic of the system to different top-soil conditions, as articulated below. In some exemplary cases, the computerized analyzing module distinguishes between changes in information collected by sensors positioned in top soil and sensors positioned in bottom soil. The term ‘top soil’ defines a selected predefined depth in the soil, for example 20 centimeters. The definition of top soil may vary from one zone to another, even in the same field, may vary according to date, type of plants that grow in the zone and the like. The main contributor to changes in the top soil is human actions such as cultivation or fields flattening. These actions influence the soil's density and its water retention properties. The bottom soil's water retention properties are maintained relatively constant, and the change dynamics are mainly influenced by the amount of water in the bottom soil (a seasonal feature) and changes in this bottom soil's draining ability.

When the computerized analyzing module manages the dynamics of the changes of information collected by sensors positioned in the top soil, the change is analyzed according to an adaptive approach that considers the field's cultivation history stored in field properties database 122 and zone properties database 124.

For example, when the computerized analyzing module manages the dynamics of the changes of information collected by sensors positioned in the top soil, the change is analyzed according to an adaptive approach that considers seasonal changes in soil properties and other properties, such as the water level and/or meteorological parameters, in the zone and compares these properties to similar zones in second field 130 and calibrates the sensors and the zones accordingly, as described above.

FIG. 5 illustrates a high level flow chart of a method of active calibration of information collected by sensors positioned in agricultural fields, according to certain embodiments. In stage 510, an event is initiated by an electronic, computerized or mechanical system and/or by a human operator. Such an event is in one embodiment any of: a simulation of a change in climate, for example heating or cooling the sensor or the sensor's vicinity; wetting the sensor; emitting signals directed at the sensor, such as electromagnetic signals; and ejecting a chemical formula towards the sensor, for example any material known as changing plants growth such as fertilizers. The event is initiated according to a predefined condition, such as reaching a cultivation condition or state, change in an image captured by a camera in the field, or other various conditions. In one embodiment, the event takes place only in some of the zones in the field, for example according to historical data stored in the system's database.

In stage 520, data is collected from the sensors about changes which occur from the moment of the event until the conditions stabilize. In one embodiment, the data is collected for a duration in which the event is known or predicted to change the readings from the sensor. For example, wetting the sensor is effective for about 45 minutes while emitting light towards the sensor is effective for about 3 minutes. In one embodiment, the reading type changes responsive to the event type. Particularly, in such an embodiment the sensor is adjustable by the system or by a human operator to optionally change the properties, values, or ranges, which are sensed. In one further embodiment, different measurements are collected for various zones in the field. For example, only humidity measurements are collected in zones 1, 5 and 12 and only temperature measurements are collected for the other zones. In some cases, only some of the measurements are collected, or the measurements are taken in various times, or in various frequencies, according to the event type, historical data or zone type.

In stage 530, the collected data of stage 520 is analyzed and compared with known samples and/or data saved in the system. Such analysis is performed automatically, for example in a central server, either controlled from the field or controlled by a team that receives readings from several fields, for example in various countries. Particularly, in one embodiment, stages 510 and 520 are performed at user device 150, the collected data then transmitted to an external central server. Alternately, the analysis is performed on user device 150 by dynamic adaption module 230.

In stage 540, a cultivation formula is adjusted based on the new data collected. The cultivation formula is then stored on memory 170 and further utilized by differential cultivation determination module 240 to determine a differential cultivation plan. The cultivation formula may include irrigation, plant type recommended for a specific zone in the field, growth prediction, lighting programs in case of indoor cultivation or in case artificial illumination is injected on the field. The cultivation formula may be adjusted only for some zones, only for a specific and limited time in the year, until the occurrence of an event associated with the plant's growth and the like. Particularly, in stage 550, differential cultivation determination module 240 is arranged to modify the differential cultivation plan responsive to the adjusted cultivation formula of stage 540. In stage 560, output module 250 is arranged to output signals corresponding to the updated cultivation plan, optionally to a cultivation system, as described above.

FIG. 6 illustrates a high level flow chart of a method of actively calibrating information collected by sensors positioned in agricultural fields by wetting the sensor's surroundings, according to certain embodiments. In stage 610, the sensor's surroundings are wetted. Wetting the sensor and/or the sensor surroundings may be performed by a person prior to installation of the sensor, or prior to positioning the sensor in the field. Alternatively, wetting the sensor may be on-demand when checking ansecond field or cultivation condition, responsive to a predefined event or condition. The sensor is in one embodiment wetted in a predetermined manner, for example to the point of saturation or just to simulate average rain in the same date.

In stage 620, data is gathered from the sensor periodically from the moment of wetting until the drying graph stabilizes. In one embodiment, the information is periodically gathered from one sensor, or from many sensors, that were wetted in stage 610, for example once every 15 seconds, and sent to a remote system for analysis. In another embodiment, the information is collected from both wetted and non-wetted sensors.

In stage 630, the gathered data of stage 620 is analyzed and compared with previously saved drying graphs. Such drying graphs are in one embodiment derived from historic sensor readings of field 100 stored on field properties database 122 and zone properties database 124. In another embodiment, other drying graphs are obtained from a remote server or database which stores drying graphs in various locations, for example sorted by soil properties or plant properties.

In stage 640, one or more drying graphs are identified as corresponding to the drying curve of stage 620, responsive to the outcome of the comparisons of stage 630. In one embodiment, more than one pattern in the database matches the drying properties, or more than one pattern is assigned a similarity value to the drying properties in a manner that exceeds a predefined threshold or correlation.

In stage 650 the area's water holding properties are derived from the best matching drying curve identified in stage 640. In stage 660, the calibration formula is updated to be able to translate the sensor's reading of the soil's volume wetness in accordance with the data collected and the lab findings of the best matching graph or pattern from the database, so as to derive an accurate indication of the status of the field area from readings of the sensor. In stage 670, new data is received from the sensor of stage 610. In stage 680, responsive to the updated calibration formula of stage 660 and the new data of stage 670, a cultivation plan for the area around the sensor of stage 610 is adjusted. In stage 690, signals corresponding to the adjusted cultivation plan of stage 680 are output, optionally to a cultivation system. In another embodiment (not shown), the event is the initialization of a drying mechanism arranged to dry the soil and the sensor measurements are analyzed to determine the drying curve.

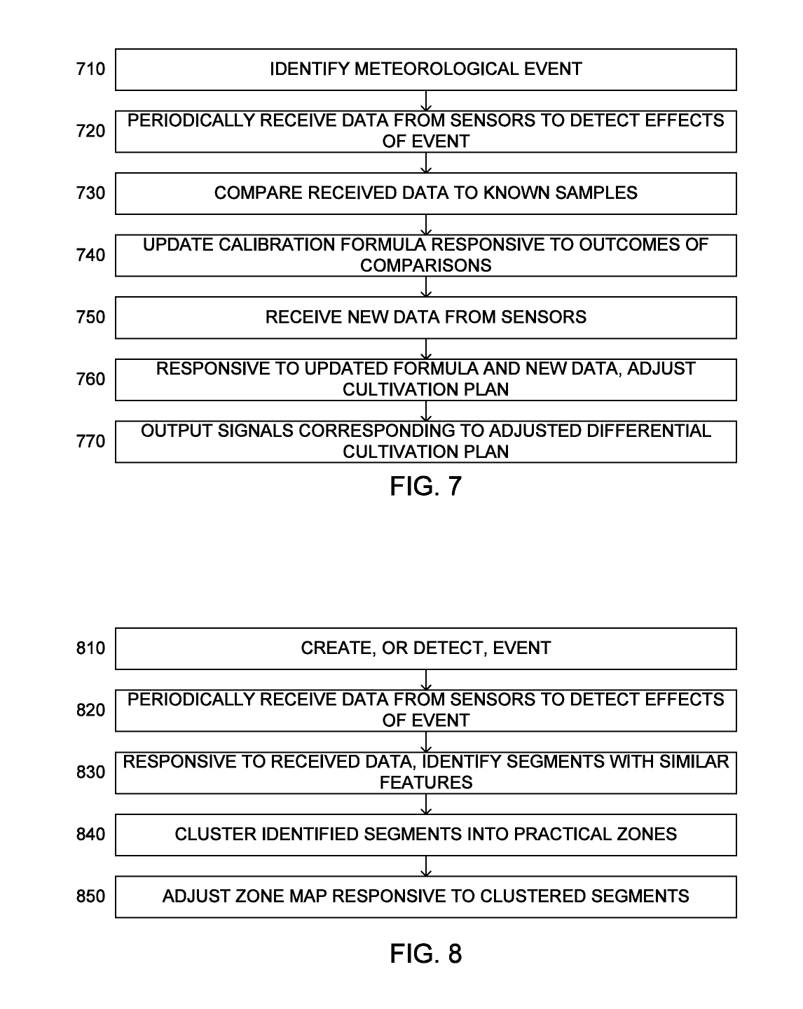

FIG. 7 illustrates a high level flow chart of a method of passively analyzing information collected from sensors positioned in a field and dynamically adjusting a differential cultivation plan, according to certain embodiments.

In stage 710, a meteorological event is identified by the system and/or the operator. The meteorological event can be rain, drought, change in climate, change in light, change from day to night and vice versa. In one embodiment, some of the events are defined according to predetermined rules.

In stage 720, data of sensor readings is periodically received from one or more sensors in a field. In one embodiment, the data is received periodically the moment of the event for a predefined period of time, for example until the measurements stabilize. In another embodiment, sensors are positioned in at least some of the zones in the field, and sensors readings are associated with the specific zone in which the sensor is positioned. In such an embodiment, the sensor measurements are also stored in zone properties database 124. In one embodiment, the predefined period of time varies according to the event type. In another embodiment, the data is collected in a different manner according to the particular event. For example, measurements are collected every 2 minutes when the event is rain and every 20 seconds when the event is a sunset.

In stage 730, the received sensor data of stage 720 is analyzed and compared to known samples, patterns and/or any type of processed or raw data saved in the system, optionally on memory 170. In stage 740 the calibration formula is updated responsive to the received sensor data of stage 720 so as to derive an accurate indication of the status of the field area from readings of the sensor.

In an embodiment where the event is rain, the system identifies changes in the drying graph's trend. Then the system finds a match between the trend and known trends already stored from historical events and the formula is adapted to translate the sensor's reading of the soil's wetness in accordance with the data collected and the lab findings of the best matching graph from the database.

In an embodiment where the event is change between day and night, the system analyzes the data from the sensors and finds the difference between data gathered during daytime and data gathered during nighttime. Assuming that the nighttime data are mainly influenced by the plant's consumption rate (without evaporation), and the daytime data are influenced mainly by evaporation (without water consumption by the plant), and assuming that the soil's drying rate is fixed during daytime and nighttime, the system calculates and isolates the rate of evaporation, the plant's water consumption rate and the soil's drying rate.

In stage 750, new data is received from the sensors of stage 720. In stage 760, responsive to the updated calibration formula of stage 740 and the new data of stage 750, a cultivation plan for each of the zones of stage 720 is adjusted. In stage 770, signals corresponding to the adjusted cultivation plan of stage 760 are output, optionally to a cultivation system.

FIG. 8 illustrates a high level flow chart of a method of identifying and analyzing zones in a field in a dynamic manner, according to certain embodiments. In stage 810, an event is optionally initiated by the computerized system and/or by a human operator. In another embodiment, instead of creating the event, the system only identifies an event, such an event of off-season irrigation.

In stage 820, data is periodically received from remote sensors, such as cameras, infra-red cameras and satellites. In one embodiment, the data is received from the time of the event until the changes are no longer relevant to the measurements, and the measurements are back to normal. The received data is in one embodiment images, video or values extracted from images or video. In another embodiment, the data also comprises spatial data which relates to information associated with the zones, such as altitude, soil type, area size or other additional properties.

In one embodiment, the information received from the sensors is combined with information from other sources such as electromagnetic or electro-conductivity mapping of the field or of some of the zones, or topographic features of at least a portion of the field. The topographic features are in one embodiment stored in the system's database or in a remote server.

When the zoning process is performed in a passive approach, no event is generated, but only identified. In such an embodiment, the event may be rain, drought, changes in level of green vegetation in at least some of the zones and others. The information extracted from the sensors, IR cameras, thermal cameras and other remote sensors during the event are in one embodiment also correlated with additional data. Such additional data are optionally topographic features, yield maps and other features.

In stage 830, the received data of stage 820 is analyzed to identify segments with similar features. In one embodiment, such segments can be specific areas in the field that react to the event in a similar manner. For example, in an embodiment where the event of stage 810 is field irrigation, some segments are likely to dry faster than others. Segments which react similarly to the event are likely to have similar field capacity.

In stage 840, segments are clustered into one or more practical zones. The practical zones are defined according to the manner in which the soil in each segment reacts to the event. For example, if 23 segments out of 200 segments have a field capacity in a predetermined range according to the analysis of stage 820, those 23 segments are defined as segments belonging to the same cluster in the field. In stage 850, a zone map of first field 100 (i.e. the separation of first field 100 into a plurality of zones) is adjusted responsive to the clustured segments of stage 820. Optionally, the adjusted zone map is output at a user interface, such as optional user interface 180 of user device 150.

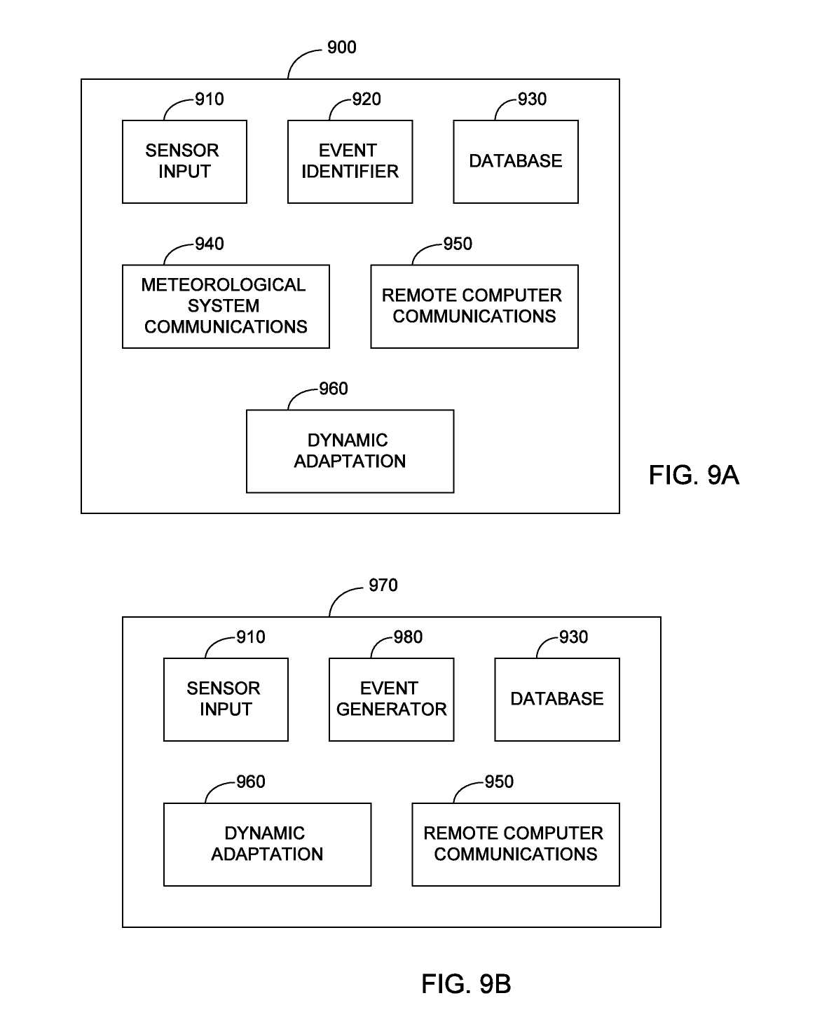

FIG. 9A illustrates a high level block diagram of a passive calibration system 900 and FIG. 9B illustrates a high level block diagram of an active calibration system 970, according to certain embodiments, FIGS. 9A-9B being described together. Passive calibration system 900 comprises: a sensor input module 910; an event identification module 920; a database 930; a meteorological system communications module 940; a remote computer communications module 950; and a dynamic adaptation module 960. In one embodiment, passive calibration system 900 is implemented by computer readable instructions stored on memory 170 of user device 150 and executed by processor 160. In another embodiment, each of sensor input module 910, event identification module 920, meteorological system communications module 940, remote computer communications module 950 and dynamic adaptation module 960 is implemented as a dedicated circuitry. In one embodiment, database 930 comprises a portion of memory 170 of user device 150.

Active calibration system 970 comprises: a sensor input module 910; a database 930; a remote computer communications module 950; a dynamic adaptation module 960; and an event generation module 980. In one embodiment, active calibration system 970 is implemented by computer readable instructions stored on memory 170 of user device 150 and executed by processor 160. In another embodiment, each of sensor input module 910, remote computer communications module 950 dynamic adaptation module 960 and event generation module 980 is implemented as a dedicated circuitry. In one embodiment, database 930 comprises a portion of memory 170 of user device 150.

Sensor input module 910 is arranged to receive signals from a plurality of sensors in communication therewith. Event identification module 920 is in communication with a meteorological event identification system and is arranged to receive therefrom an indication of a meteorological event, such as climate change, change from night to day, etc. In one embodiment (not shown), an interface to a meteorological system is provided and is arranged to extract climate information from an additional official source.

Database 930 of each of passive calibration system 900 and active calibration system 970 stores history of readings and measurements collected from the sensors in the first field and/or second fields. In one embodiment, database 930 further includes predetermined event generation rules and/or analyzation rules. Meteorological system communications module 940 of passive calibration system 900 is in communication with a meteorological system and is arranged to receive therefrom an indication of a meteorological event. Remote computer communications module 950 is arranged to receive data from a remote computer to store in database 930. In one embodiment, data is further transmitted by remote computer communications module 950 to the remote computer or network, such as a central unit that gathers information from many farms in many counties or countries.

Dynamic adaptation module 960 is arranged to analyze the sensor measurements and adjust calibration formulas, as described above. Dynamic adaptation module 960 in one embodiment uses information stored in the database 930 to find matches for the received sensor measurements of sensor input module 910 and adjusts the respective cultivation formulas or predictions.

When the dynamic analysis is performed on an active approach, event generation module 980, is arranged to output commands to an appropriate system, such as an irrigation system, to initiate an event, as described above. Event generation module 980 in one embodiment receives commands from a computerized control unit or can be activated by a person operating the system. The sensor measurements collected after the event is generated are stored on database 930.

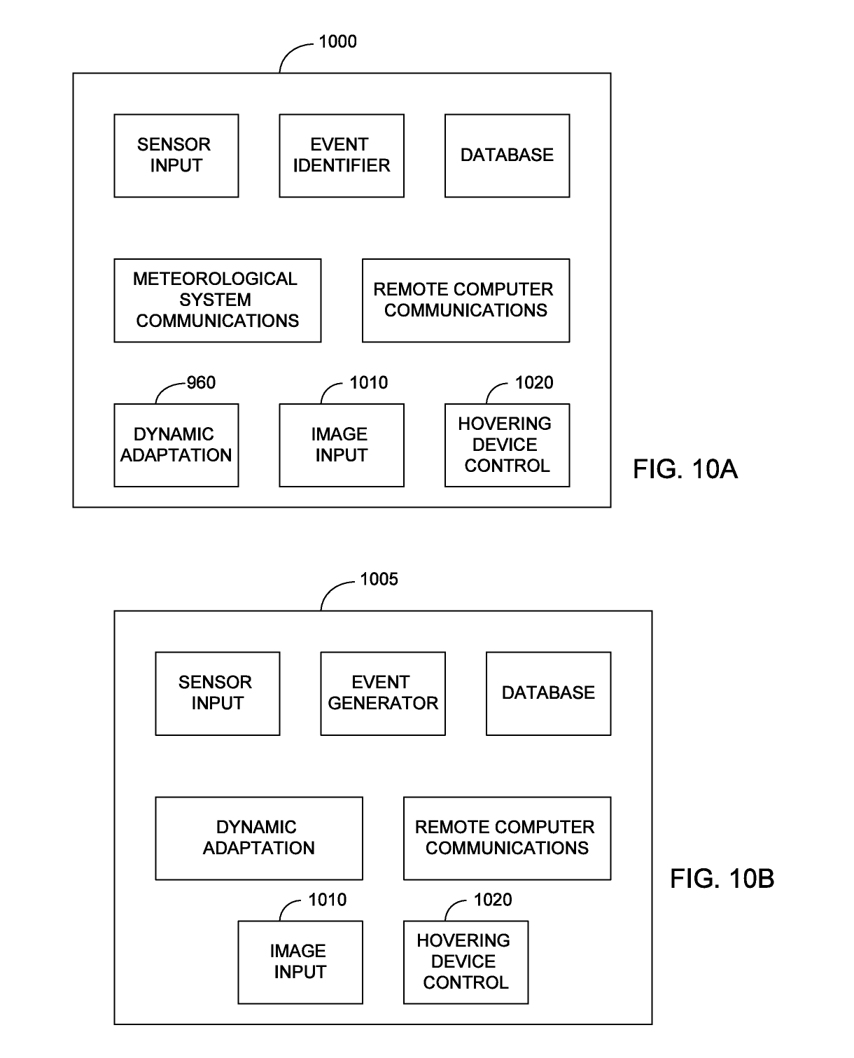

FIGS. 10A-10B illustrate systems for identifying and analyzing zones in a field in a dynamic manner, according to certain embodiments. Particularly, FIG. 10A illustrates a high level block diagram of a passive zone identification and analyzation system 1000 and FIG. 10B illustrates a high level block diagram of an active zone identification and analyzation system 1005. Passive zone identification and analyzation system 1000 is in all respects similar to passive calibration system 900, with the addition of an image input module 1010. Similarly, active zone identification and analyzation system 1005 is in all respects similar to active calibration system 970, with the addition of an image input module 1010. Image input module 1010 of each of passive zone identification and analyzation system 1000 and active zone identification and analyzation system 1005 is in communication with an image capturing unit, such as an imaging or video camera, optionally an IR camera. In one embodiment, image input module 1010 is further in communication with a satellite. In another embodiment, image input module 1010 is further in communication with a hovering device, such as a drone positioned above the field.

Image input module 1010 is arranged to receive images of the field taken from the time of the occurrence of the event until the received sensor measurements return back to normal, as described above. In one embodiment, a hovering device control module 1020 is further provided, hovering device control module 1020 in communication with a hovering device and arranged to control the hovering device to take-off and land responsive to the analysis performed by dynamic adaptation module 960 indicating that the field is being analyzed. The received images are analyzed by dynamic adaptation module 960 during an event to define zones having similar irrigation properties.

In summary, the changes over time made by man and nature significantly affect the soil wetting index of the field and require a dynamic approach to enable and adaptive irrigation solution. This is accomplished in one, or both, of two methods: an active modality approach, where the system actively initiates an event and analyzes the sensor data which follows the event; and a passive modality approach, where the system exploits a natural event and analyzes the sensor data which follows the event.

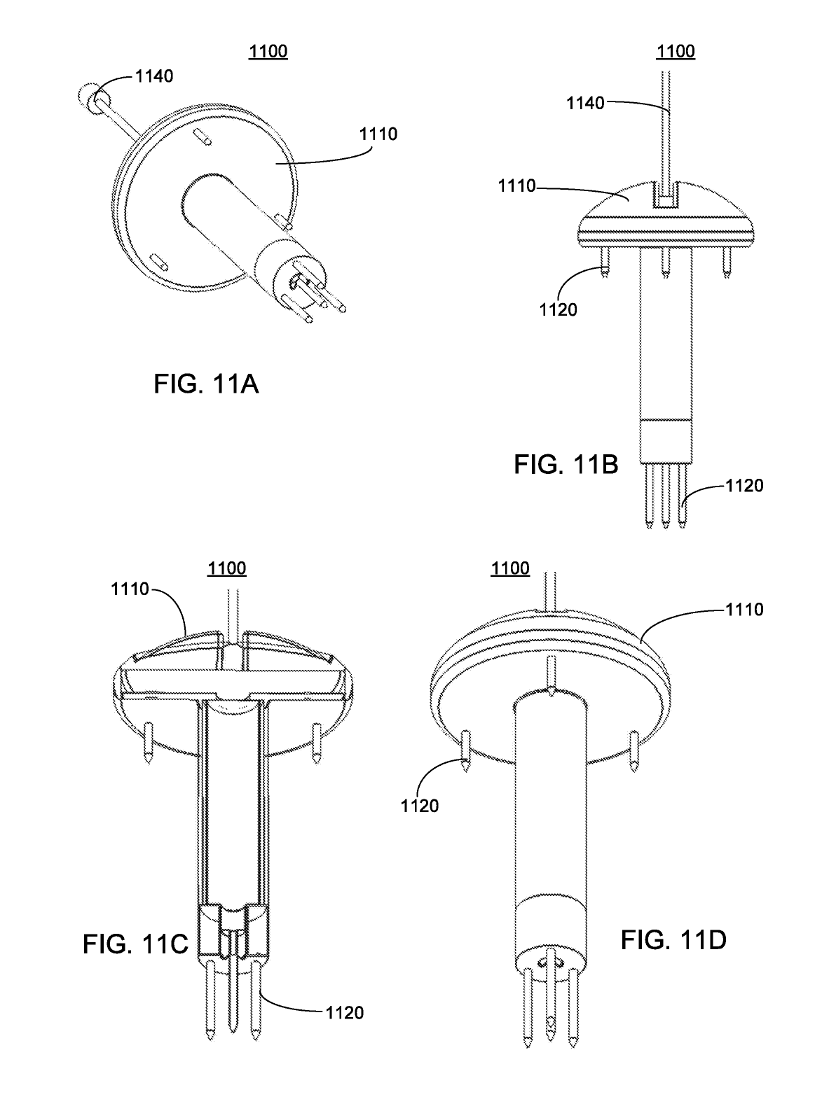

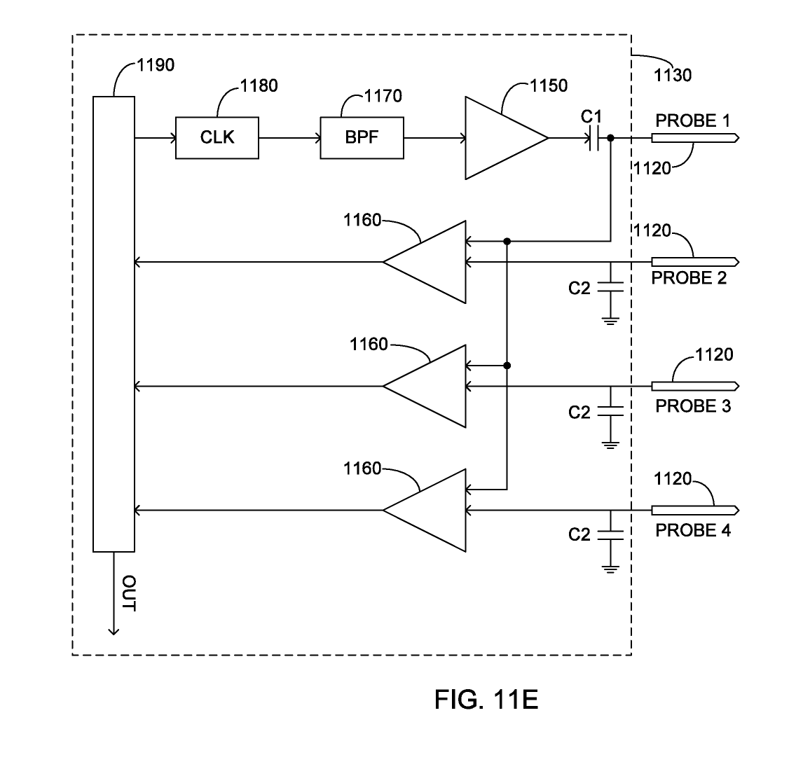

FIGS. 11A-11D illustrate various high level view of a sensor 1100, according to certain embodiments. In one embodiment, sensors 108, 110, 112, 138, 140 and 142 are each implemented as a sensor 1100. Sensor 1100 comprises: a body 1110; a plurality of probes 1120; a calibration circuitry 1130 (not shown); and an antenna 1140. FIG. 11E illustrates a high level schematic diagram of calibration circuitry 1130, FIGS. 11A-11E being described together. Probes 1120 extend from body 1110 into the soil. Antenna 1140 extends from body 1110 and in one embodiment is in communication with communications module 190 of user device 150.

The moisture measurement of probes 1120 is based on the physical fact that between two electrodes inserted into the soil there exists a resistance dependent on the moisture, the quantity of salt and minerals, the distance between the two electrodes, and other factors. It is accepted that the conversion scheme of a measurement with two electrodes is a capacitor in parallel with a resistor. The resistor represents the quantity of salts, while the capacitor represents the distance between the electrodes and the quantity of water. Most of the measurement methods used today measure the capacity and resistance and estimate the moisture. One of the most accurate methods is called Time Domain Reflectometry. This is based on transmitting a high frequency wave and measuring the delay created by the gap in three directions. The higher the working frequency, the greater the accuracy. However, since the measurement is indirect, it is necessary to construct the transmission function between the measurement result and the level of moisture in practice, i.e. calibrate the measurement results.

Calibration circuitry 1130 comprises: a capacitor C1; a plurality of capacitors C2; a radio frequency (RF) power amplifier 1150; a plurality of RF phase detectors 1160; a band pass filter 1170; a clock 1180, optionally with a frequency of 2.4 GHz; and a control circuitry 1190. A first probe 1120 is coupled to a first end of capacitor C1 and a second end of capacitor C1 is coupled to an output of RF power amplifier 1150. The first end of capacitor C1 is further coupled to a first input of each RF phase detector 1160. An input of RF power amplifier 1150 is coupled to an output of band pass filter 1170 and an input of band pass filter 1170 is coupled to an output of clock 1180. An input of clock 1180 is couple to an output of control circuitry 1190. Each of the other probes 1120 is coupled to a first end of a respective capacitor C2 and a second input of a respective RF phase detector 1160. A second end of each capacitor C2 is coupled to a common potential. An output of each RF phase detector 1160 is coupled to a respective input of control circuitry 1190.

In operation, control circuitry 1190 is arranged to control clock 1180 to output a clock signal, optionally above 2.4 GHz. Band pass filter 1170 is arranged to output only the desired frequencies for probe 1120. RF power amplifier 1150 is arranged to amplify the transmission capacity to about 1 Watt. The transmission strength is optionally controlled by control circuitry 1190 and is optionally based on MOSFET-RF amplifier technology.

The output pulses are received at the remaining probes 1120 after a delay, due to the soil moisture level. In particular, as illustrated in FIGS. 11A-11D, there are 4 probes 1120 inserted into the soil, with probe 1, i.e. the transmission probe, in the center and receiving probes 2, 3 and 4 disposed around probe 1, the distance between probe 1 and each of probes 2, 3 and 4 being about half a wave length of the signal output at probe 1.

Each RF phase detector 1160 is arranged to measure the phase difference between the transmitted wave and the wave received at the respective receiving probe. This difference is translated into voltage, which is sampled by control circuitry 1190 for processing. Control circuitry 1190 is arranged to calculate the delay and determine the moisture level of the soil responsive thereto.

As described above, events can be initiated for calibration of sensor measurements. For an event of heating the soil, pulses are output at probe 1. Since the soil serves as a transmission line, this creates an effect similar to a microwave, such that the high frequency shaking of the water molecule causes the water to heat up and evaporate at a fixed slow rate. The quantity of energy required to evaporate the water is as follows:

E=m·c·ΔT EQ. 1

where m is 1 gram of water, c is the heat capacity of water (which equals 1) and ΔT is the difference between the current water temperature and 100 degrees C. For water at a temperature of 25 degrees C., the energy needed is thus 75 calories, i.e. 314 joules. Thus, in order to heat up the water within 10 minutes, the output signal is at least 0.5 Watts.

Similarly, an event can be initiated to dry the soil to determine a drying curve, as described above. The transmission of probe 1 thus heats up the water in the soil and causes evaporation of the water, thereby drying the soil.

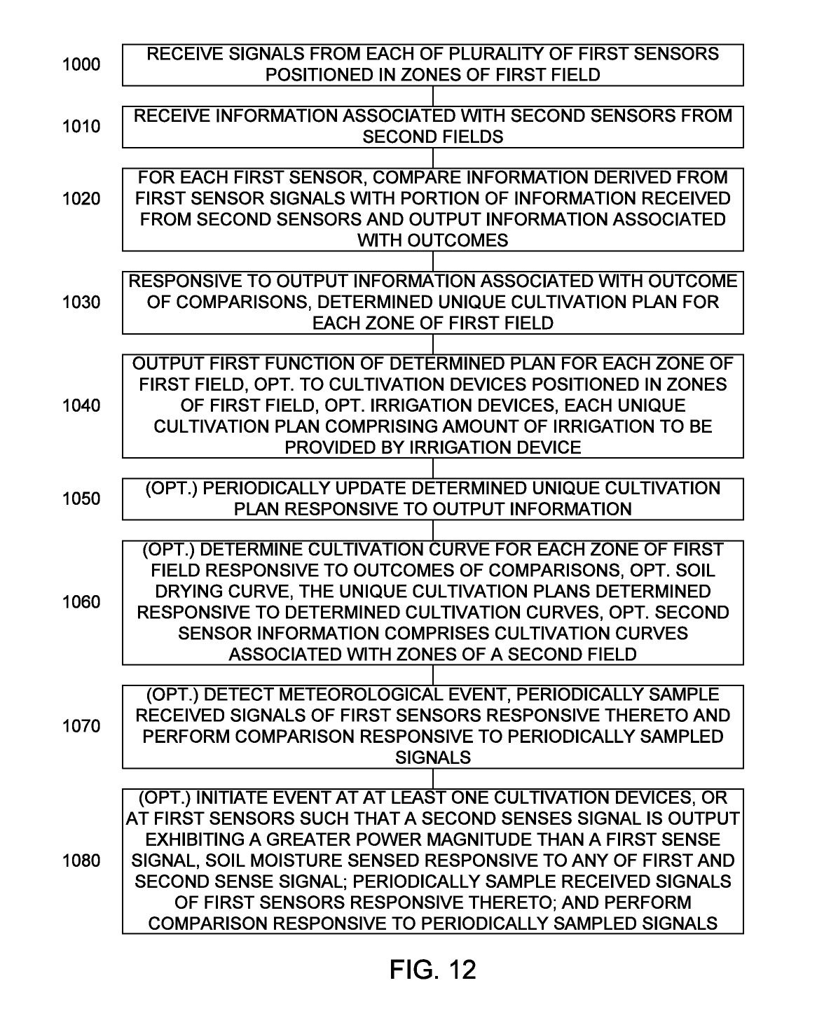

FIG. 12 illustrates a high level flow chart of an automated dynamic adaptive differential agricultural cultivation method, according to certain embodiments. In stage 1000, signals are received from each of a plurality of first sensors, each of the plurality of first sensors positioned in a respective one of a plurality of zones of a first field.

In stage 1010, information associated with a plurality of second sensors from a plurality of second fields is received. Each of the plurality of second fields are different than the first field. In stage 1020, for each of the plurality of first sensors of stage 1000, information derived from the first sensor signal is compared with a portion of the received information of stage 1010. Additionally, information associated with the outcome of the comparisons is output. In stage 1030, responsive to the output information of stage 1020, a unique cultivation plan is determined for each zone of the first field of stage 1000.

In stage 1040, a function of the determined unique cultivation plan for each of the plurality of zones of the first field of stage 1030 is output. Optionally, the function of each of the determined unique cultivation plans is output to a respective one of a plurality of cultivation devices, each of the plurality of cultivation devices positioned in a respective one of the plurality of zones of the first field. Optionally, the plurality of cultivation devices are irrigation devices, each of the determined unique cultivation plan functions comprising the amount of irrigation to be provided by the respective irrigation device.

In optional stage 1050, the determined unique cultivation plans of stage 1030, for each zone of the first field, are periodically updated responsive to the output information associated with the outcome of the comparisons of stage 1020.

In optional stage 1060, a cultivation curve is determined for each zone of the first field of stage 1000 responsive to the information associated with the outcome of the comparisons of stage 1020. Optionally, the cultivation curve is a soil drying curve. The unique cultivation plans of stage 1030 are determined responsive to the determined cultivation curves. Optionally, the information associated with the second sensors of stage 1010 comprises a plurality of cultivation curves, each of the plurality of cultivation curves associated with a respective zone of one of the plurality of second fields.

In optional stage 1070, a meteorological event is detected. Responsive to the detected meteorological event, signals received from the first sensors of stage 1000 are periodically sampled and the comparisons of stage 1020 are performed responsive to the periodically sampled signals.

In optional stage 1080, an event is initiated at at least one cultivation device and/or at at least one first sensor. Particularly, an event initiated at a cultivation device comprises a predetermined activation of the cultivation device. Each first sensor is to alternately output a first sense signal exhibiting a first power magnitude and a second sense signal exhibiting a second power magnitude, the second power magnitude greater than the first power magnitude. Each of the plurality of first sensors is further arranged to sense the surrounding soil moisture level responsive to any of the respective output first sense signal and second sense signal. An event initiated at a first sensor comprises controlling the first sensor to output the second sense signal. Responsive to the event initiation, either at the cultivation device or the first sensor, signals received from the first sensors of stage 1000 are periodically sampled and the comparisons of stage 1020 are performed responsive to the periodically sampled signals.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination. In particular, the invention has been described with an identification of each powered device by a class, however this is not meant to be limiting in any way. In an alternative embodiment, all powered device are treated equally, and thus the identification of class with its associated power requirements is not required.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. An automated dynamic adaptive differential agricultural cultivation system, comprising:
a sensor input module, said sensor input module arranged to receive signals from each of a plurality of first sensors, each of the plurality of first sensors positioned in a respective one of a plurality of zones of a first field;
a multiple field input module, said multiple field input module arranged to receive information associated with second sensors from a plurality of second fields, said second fields different than the first field;
a dynamic adaptation module, said dynamic adaptation module arranged, for each of the first sensors, to compare information derived from said signals received from the respective first sensor with a portion of said information received by said multiple field input module from the second sensors and output information associated with the outcome of said comparison;
a differential cultivation determination module, said differential cultivation determination module arranged, responsive to said output information of said dynamic adaptation module, to determine a unique cultivation plan for each of the plurality of zones of the first field; and
an output module, said output module arranged to output a first function of said determined unique cultivation plan for each of the plurality of zones of the first field.

2. The system of claim 1, wherein said differential cultivation determination module is arranged to periodically update said determined unique cultivation plans responsive to said information output by said dynamic adaptation module.

3. The system of claim 1, wherein said dynamic adaption module is arranged to determine a cultivation curve for each of the plurality of zones of the first field, responsive to the outcomes of said respective comparisons, and
wherein said unique cultivation plan of each of the plurality of zones is determined responsive to said determined cultivation curve.

4. The system of claim 3, wherein said determined cultivation curve is a soil drying curve.

5. The system of claim 3, wherein said information received by said multiple field input module comprises a plurality of cultivation curves, each of the plurality of cultivation curves associated with a respective zone of one of the plurality of second fields.

6. The system of claim 3, further comprising an event identification module, said event identification module arranged to detect a meteorological event,
wherein responsive to said meteorological event detection, said dynamic adaption module is arrange to periodically sample said received signals from each of the plurality of first sensors and perform said comparison of information responsive to said periodically sampled signals.

7. The system of claim 3, further comprising an event initiation module, said event initiation module in communication with each of a plurality of cultivation devices, each of the plurality of cultivation devices positioned in a respective one of the plurality of zones of the first field, said event initiation module arranged to initiate an event at at least one of the plurality of cultivation devices,
wherein responsive to said event initiation, said dynamic adaptation module is arranged to periodically sample said received signals from each of the plurality of first sensors and perform said comparison of information responsive to said periodically sampled signals.

8. The system of claim 3, further comprising:
said plurality of first sensors; and
an event initiation module, said event initiation module in communication with each of said plurality of first sensors,
wherein each of said plurality of first sensors is arranged to alternately output a first sense signal exhibiting a first power magnitude and a second sense signal exhibiting a second power magnitude, said second power magnitude greater than said first power magnitude,
wherein each of said plurality of first sensors is further arranged to sense the surrounding soil moisture level responsive to any of said respective output first sense signal and second sense signal,
wherein said event initiation module is arranged to initiate an event at at least one of said plurality of first sensors, such that each of said plurality of first sensors is arranged to output said second sense signal, and
wherein responsive to said event initiation, said dynamic adaptation module is arranged to periodically sample said received signals from each of the plurality of first sensors and perform said comparison of information responsive to said periodically sampled signals.

9. The system of claim 1, wherein said output module is in communication with each of a plurality of cultivation devices, each of the plurality of cultivation devices positioned in a respective one of the zones of the first field, and
wherein, for each of the plurality of zones of the first field, said output module is arrange to output said respective determined unique cultivation plan function to the respective one of the plurality of cultivation devices positioned in the respective zone.

10. The system of claim 9, wherein each of the plurality of cultivation devices is an irrigation device, each of said determined unique cultivation plan functions comprising the amount of irrigation to be provided by the respective irrigation device.

11. An automated dynamic adaptive differential agricultural cultivation method, the method comprising:
receiving signals from each of a plurality of first sensors, each of the plurality of first sensors positioned in a respective one of a plurality of zones of a first field;
receiving information associated with second sensors from a plurality of second fields, said second fields different than the first field;
for each of the first sensors, comparing information derived from said signals received from the respective first sensor with a portion of said information received from the second sensors and outputting information associated with the outcome of said comparison;
responsive to said output information associated with the outcome of said comparison, determining a unique cultivation plan for each of the plurality of zones of the first field; and
outputting a first function of said determined unique cultivation plan for each of the plurality of zones of the first field.

12. The method of claim 11, further comprising periodically updating said determined unique cultivation plans responsive to said output information.

13. The method of claim 11, further comprising determining a cultivation curve for each of the plurality of zones of the first field, responsive to the outcomes of said respective comparisons, and
wherein said unique cultivation plan of each of the plurality of zones is determined responsive to said determined cultivation curve.

14. The method of claim 13, wherein said determined cultivation curve is a soil drying curve.

15. The method of claim 13, wherein said received information associated with the second sensors comprises a plurality of cultivation curves, each of the plurality of cultivation curves associated with a respective zone of one of the plurality of second fields.

16. The method of claim 13, further comprising:
detecting a meteorological event;
responsive to said meteorological event detection, periodically sampling said received signals from each of the plurality of first sensors; and
performing said comparison of information responsive to said periodically sampled signals.

17. The method of claim 13, further comprising:
initiating an event at at least one of a plurality of cultivation devices, each of the plurality of cultivation devices positioned in a respective one of the plurality of zones of the first field;
responsive to said event initiation, periodically sampling said received signals from each of the plurality of first sensors; and
performing said comparison of information responsive to said periodically sampled signals.

18. The method of claim 13, wherein each of the plurality of first sensors is arranged to alternately output a first sense signal exhibiting a first power magnitude and a second sense signal exhibiting a second power magnitude, the second power magnitude greater than the first power magnitude,
wherein each of the plurality of first sensors is further arranged to sense the surrounding soil moisture level responsive to any of the respective output first sense signal and second sense signal,
wherein the method further comprises:
initiating an event at at least one of the plurality of first sensors, such that each of the plurality of first sensors is arranged to output the second sense signal;
responsive to said event initiation, periodically sampling said received signals from each of the plurality of first sensors; and
performing said comparison of information responsive to said periodically sampled signals.

19. The method of claim 11, further comprising, for each of the plurality of zones of the first field, outputting said respective first function of said determined unique cultivation plan to a respective one of a plurality of cultivation devices, each of the plurality of cultivation devices positioned in a respective one of the plurality of zones of the first field.

20. The method of claim 19, wherein each of the plurality of cultivation devices is an irrigation device, each of said determined unique cultivation plan functions comprising the amount of irrigation to be provided by the respective irrigation device.
